(19) United States
(12) Patent Application Publication
(10) Pub. No.: US 2009/0236224 A1
(43) Pub. Date: Sep. 24, 2009

(54) ELECTROCHEMICAL SENSOR AND METHOD FOR MANUFACTURING THE SAME

(75) Inventors: Masaharu Yamasato, Tokyo (JP); Takao Takami, Tokyo (JP); Taisuke Nakano, Tokyo (JP); Shoji Moroguchi, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DKK-TOA CORPORATION, Tokyo (JP)

(21) Appl. No.: 11/721,542

(22) PCT Filed: Dec. 13, 2005
(86) PCT No.: PCT/JP05/23204

§ 371 Date: Jun. 13, 2007

(30) Foreign Application Priority Data
Dec. 15, 2004 (JP) 2004-363740

(51) Int. Cl. G01N 27/40; C03B 23/20; C03B 23/207

(52) U.S. Cl. 204/415; 65/36; 65/46; 65/42

(57) ABSTRACT

It is an object of the present invention to provide an electrochemical sensor which can prevent occurrence of cracks at the welding portion between a support tube made of lead-free glass and a sensitive glass membrane or ceramics, and a method for manufacturing the same. The electrochemical sensor 100 has a configuration such that the sensitive glass membrane 2A is welded to the support tube 1 made of lead-free glass with a lead glass layer 3A between the sensitive glass membrane 2A and the support tube 1. According to the present invention, there is also provided the electrochemical sensor in which the ceramics 2B for a junction is welded to the support tube 1 made of lead-free glass with a lead glass layer 3B between the ceramics 2B and the support tube 1.

### TECHNICAL FIELD

The present invention relates to an electrochemical sensor such as a pH electrode comprising a support tube to which a sensitive glass membrane or ceramics is welded, and a method for manufacturing the same.

### BACKGROUND ART

Conventionally, in a glass electrode such as a pH electrode, a sensitive glass membrane (pH-sensitive membrane) serving as a sensitive part is generally provided, by welding, to an extremity of an electrode supporting member formed of glass. As a material for the sensitive glass membrane, Li-based glass containing SiO₂, BaO, Li₂O, La₂O₃, Cs₂CO₃, TiO₂, etc. (which may further contain Ta₂O₅, Pr₂O₃, Cr₂O₃, etc.) is used, for example. Many kinds of useful Li-based glass have a coefficient of thermal expansion (“CTE”) (coefficient of linear thermal expansion; same applies to others hereafter) of 80 to 120×10⁻⁷/° C. (at 30 to 380° C.; same applies to others hereafter).

On the other hand, in a reference electrode, a liquid junction is provided to establish electric conduction with a sample liquid. The reference electrode may be used together with a pH electrode, etc., or formed integrally with a pH electrode, etc. as a combined electrode. Ceramics, or more specifically, porous ceramics is widely used as the junction. The junction is usually sealed in a wall of an electrode supporting member formed of glass. Many kinds of useful ceramics for the junction have a CTE of 80 to 110×10⁻⁷/° C.

In order to conduct good welding, sealing or inclusion (which may be comprehensively referred to as “welding”) between the sensitive glass membrane or ceramics and the electrode supporting member, and to prevent cracks caused by temperature change at the welding portion, it is necessary to bring the CTE of the electrode supporting member to that of the sensitive part or ceramics.

As a material for the electrode supporting member responding to the above-mentioned needs, a glass composition containing lead, or more specifically, PbO (generally referred to as “lead glass”) has generally been used heretofore. Such a glass composition contains, for example, BaO, Al₂O₃, Na₂O, K₂O, etc. as well as SiO₂ and PbO.

A typical lead glass has a CTE of 94×10⁻⁷/° C. which is close to that of the sensitive glass membrane or ceramics, and has a good welding property. Also, lead glass has a low-temperature softening property, and is good in processability and workability. Further, lead glass is good in transparency, water resistance and weather resistance.

However, from the point of view of environment-friendliness, there is recently an increasing demand for replacing lead glass with a glass composition not containing lead (hereinafter referred to as “lead-free glass”).

The present applicant proposed, as disclosed in Japanese Patent Application Publication No. 2005-207887, a lead-free glass composition being useful as a material for an electrode supporting member of an electrochemical sensor, which has a good welding property to a sensitive glass membrane, ceramics or a platinum electrode. Also, this lead-free glass is relatively low-temperature softening, and is good in processability and workability. Further, this lead-free glass is good in water resistance, weather resistance and transparency.

However, according to the studies of the present inventors, it is revealed that in the case where a sensitive glass membrane is welded onto a tubular electrode supporting member, i.e. support tube (glass stem tube) formed of lead-free glass, or where ceramics for junction is welded onto the support tube, cracks may occur at the welding portion or sealing portion under some service conditions.

The CTE of the sensitive glass membrane somewhat varies with the kind of glass composition thereof. Particularly in a pH-sensitive glass membrane for high alkalinity, cracks tend to occur easily from the joint between the sensitive glass membrane and the support tube made of lead-free glass in the measurement for a long period of time longer than five hours at a high temperature higher than 100° C., although no particular problem in the measurement on a room-temperature level is posed.

With respect to a junction made of ceramics, cracks tend to occur easily at the sealing portion of the junction in the support tube made of lead-free glass, depending on ceramics composition, even in the measurement on a room-temperature level. Particularly, cracks tend to occur easily in the case where a junction formed of alumina-based ceramics is used.

The mechanism in which cracks tend to occur easily at the joint between the support tube made of lead-free glass and the sensitive glass membrane or the junction made of ceramics is not entirely clear. According to the studies carried out by the present inventors, however, it is considered to be caused by the following difference between lead glass and lead-free glass.

The lead-free glass composing the support tube in which cracks occur as mentioned above has a CTE of 94.5×10⁻⁷/° C. which is generally equal to the CTE of the typical conventional lead glass (94×10⁻⁷/° C.). Therefore, the lead-free glass is considered a suitable substitute for the lead glass. However, the lead-free glass has hardness in its molten state, and this is considered to prevent achievement of a sufficient processing accuracy. In other words, when forming the support tube from the conventional lead glass, the lead glass has softness in its molten state because of lead contained in its composition, and thus a extremely good processability is considered to be obtained.

The difference in softness in molten state between the lead-free glass and the lead glass seems to be particularly remarkable when an object to be welded has a CTE far different from that of the support tube (CTE; membrane for high alkalinity: 115 to 120×10⁻⁷/° C., alumina-based ceramics A-017: 84×10⁻⁷/° C.).

More specifically, lead glass is considered to permit welding of an object to be welded with a sufficient processing accuracy because of the easy processability resulting from softness in its molten state. Also, lead glass is considered to express flexibility by containing lead, and is considered to be able to absorb the difference in CTE from the object to be welded. As a result, a sufficient durability can be maintained even under severe service conditions such as a high temperature and a high alkalinity. In lead-free glass, in contrast, hardness in its molten state is considered to lead to an insufficient affinity with the object to be welded, and is considered to make it difficult to obtain a sufficient processing accuracy. Also, in lead-free glass, lack of flexibility is considered to prevent compensating for the difference in CTE from the object to be welded, and is considered to cause cracks during use.

Such an advantage of lead glass has not rather been noted since it has been the usual practice to manufacture a support tube for an electrochemical sensor from lead glass.

### DISCLOSURE OF INVENTION

It is therefore an object of the present invention to provide an electrochemical sensor which can prevent occurrence of cracks at the welding portion between a support tube and a sensitive glass membrane or ceramics, and a method for manufacturing the same.

The foregoing object is achieved by the use of the image forming apparatus of the present invention. In summary, the first aspect of the present invention provides an electrochemical sensor wherein a sensitive glass membrane is welded to a support tube made of lead-free glass with a lead glass layer between the sensitive glass membrane and the support tube. According to an embodiment of the present invention, an annular lead glass layer is welded to an annular end face of the support tube, and the sensitive glass membrane is welded to an end face of the annular lead glass layer. Ceramics may further be welded to the support tube with a lead glass layer between the ceramics and the support tube. According to another embodiment of the present invention, the support tube has a double tube structure having an inner tube and an outer tube; a tube end of the outer tube is welded to a tube end of the inner tube and sealed thereto; and the annular end face is formed on the tube end of the support tube. Ceramics for a junction may be welded to the outer tube of the support tube with a lead glass layer between the ceramics and the outer tube of the support tube. The electrochemical sensor may be a pH electrode.

According to the second aspect of the present invention, there is provided an electrochemical sensor wherein ceramics for a junction is welded to a support tube made of lead-free glass with a lead glass layer between the ceramics and the support tube. The electrochemical sensor may be a reference electrode.

According to the third aspect of the present invention, there is provided an electrochemical sensor wherein a sensitive glass membrane or ceramics for a junction is welded to a support tube made of a material having a coefficient of thermal expansion (coefficient of linear thermal expansion) of 94±20×10⁻⁷/° C. with a lead glass layer between the sensitive glass membrane or the ceramics and the support tube.

According to the fourth aspect of the present invention, there is provided a method for manufacturing an electrochemical sensor comprising welding a sensitive glass membrane to a support tube made of lead-free glass with a lead glass layer between the sensitive glass membrane and the support tube. According to an embodiment of the present invention, the method comprises the steps of: (a) welding an annular lead glass layer to an annular end face of the support tube made of lead-free glass; and (b) welding the sensitive glass membrane to an end face of the annular lead glass layer. Step (a) may comprise a step of welding an annular member made of lead glass having substantially the same shape as that of the annular end face of the support tube to the annular end face of the support tube. Step (b) may comprise a step of welding a molten membrane seed of the sensitive glass membrane to the end face of the lead glass layer, and then swelling the membrane seed into a desired spherical shape by blowing air into the support tube.

According to the fifth aspect of the present invention, there is provided a method for manufacturing an electrochemical sensor comprising welding ceramics for a junction to a support tube made of lead-free glass with a lead glass layer between the ceramics and the support tube. According to an embodiment of the present invention, the method comprises the steps of: (i) putting the ceramics for the junction into a tubular member made of lead glass substantially engaging with the ceramics for the junction; (ii) inserting a composite member, formed in step (i), of the ceramics for the junction and the tubular member made of lead glass into a hole opened in the support tube made of lead-free glass; and (iii) welding the ceramics for the junction, together with the tubular member made of lead glass, to the support tube. The method may further comprise a step of partially welding the tubular member made of lead glass and the ceramics for the junction between step (i) and step (ii). According to another embodiment of the present invention, the method may comprise the steps of: (I) opening a first hole in the support tube made of lead-free glass; (II) closing the first hole by welding lead glass to the first hole opened in step (I); (III) opening a second hole substantially at the center of the lead glass having closed the first hole in step (II) so as to leave the lead glass around the second hole; and (IV) inserting the ceramics for the junction into the second hole opened in step (III), and then welding the ceramics to the second hole.

According to the sixth aspect of the present invention, there is provided a method for manufacturing an electrochemical sensor comprising welding a sensitive glass membrane or ceramics for a junction to a support tube made of a material having a coefficient of thermal expansion (coefficient of linear thermal expansion) of 94±20×10⁻⁷/° C. with a lead glass layer between the sensitive glass membrane or the ceramics and the support tube.

### BRIEF DESCRIPTION OF THE DRAWINGS

FIG. 1 is a schematic sectional view of the main part of an embodiment of the electrochemical sensor (combined pH electrode) according to the present invention;

FIG. 2 is a sectional view of the support tube 1 for describing the method for manufacturing the electrochemical sensor shown in FIG. 1;

FIG. 3 is a schematic view illustrating the step of welding the sensitive glass membrane to the support tube in the method for manufacturing the electrochemical sensor shown in FIG. 1;

FIG. 4 is a schematic view illustrating the step of attaching a binder tube to a junction in the method for manufacturing the electrochemical sensor shown in FIG. 1;

FIG. 5 is a schematic view illustrating an example of the step of welding the junction to the support tube in the method for manufacturing the electrochemical sensor shown in FIG. 1;

FIG. 6 is a schematic view illustrating another example of the step of welding the junction to the support tube in the method for manufacturing the electrochemical sensor shown in FIG. 1.;

FIG. 7 is a schematic sectional view of the main part of another embodiment of the electrochemical sensor (pH glass electrode) according to the present invention; and

FIG. 8 is a schematic sectional view of the main part of yet another embodiment of the electrochemical sensor (reference electrode) according to the present invention.

### BEST MODE FOR CARRYING OUT THE INVENTION

The electrochemical sensor and the method for manufacturing the same according to the present invention will now be described further in detail with reference to the drawings.

### Embodiment 1

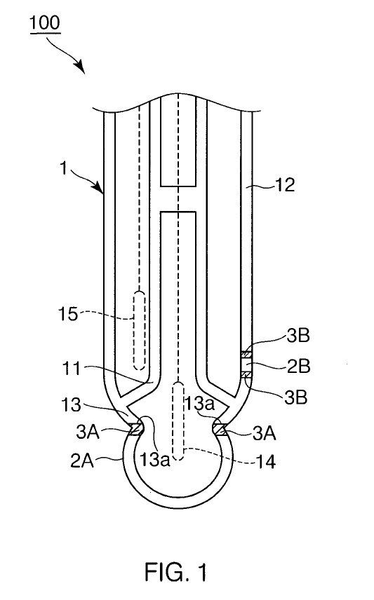

FIG. 1 illustrates an embodiment of the electrochemical sensor of the present invention. In this embodiment, the electrochemical sensor takes the form of a pH electrode, and particularly, a combined pH electrode configured by integrally forming a measurement electrode and a reference electrode (hereinafter simply referred to as “pH electrode”).

The pH electrode 100 has a double tube structure with glass tubes (i.e., double glass tube), as a support tube (glass stem tube) 1 serving as a tubular electrode supporting member. The double tube structure is formed by integrally sealing tube ends 13 of an inner tube 11 and an outer tube 12 by welding. Furthermore, a sensitive glass membrane (pH-sensitive glass membrane) 2A sensing a pH is integrally welded to the tube end 13 of the support tube 1.

An internal electrode for measurement electrode 14 is arranged inside the inner tube 11, and the interior of the inner tube 11 is filled with an internal liquid for measurement electrode. An internal electrode for reference electrode 15 is arranged inside an annular space formed by the inner tube 11 and the outer tube 12, and the interior of the annular space is filled with an internal liquid for reference electrode.

A junction 2B formed with ceramics is sealed in the side of the lower part of the outer tube 12. The junction 2B passes from the outside of the outer tube 12 to the inside of the outer tube 12 (i.e., to the tubular space between the inner tube 11 and the outer tube 12), thus permitting electric continuity between the outer tube 12 and the sample liquid outside the pH electrode 100.

The pH measurement electrode is configured having the inner tube 11, the sensitive glass membrane 2A and the internal electrode 14, and the reference electrode is configured having the outer tube 12, the junction 2B and the internal electrode for reference electrode 15.

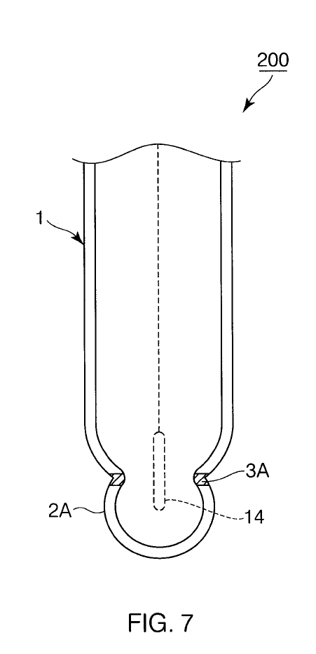

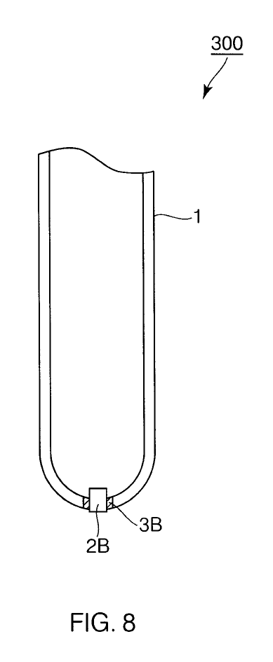

Although, the support tube 1 is the double glass tube having the inner tube 11 and the outer tube 12 in this embodiment, the support tube 1 may be a single tube as shown in FIG. 7, and the pH electrode 200 may of course be a single-type measurement electrode. In this case, the sensitive glass membrane 2A is welded to the tube end 13 of the support tube 1 which is a single tube. As shown in FIG. 8, on the other hand, a single-type reference electrode 300 may be configured by providing a junction 2B in a support tube 1 which is a single tube. In this case, the junction 2B may be provided at the extremity of the support tube 1 as shown in FIG. 8, or on the side thereof. In FIGS. 7 and 8, the same reference numerals are assigned to elements having substantially the same or corresponding functions or configurations as those of the pH electrode 100 shown in FIG. 1. In the present specification, the term “electrochemical sensor” is used so as to encompass also the single-type reference electrode.

In this embodiment, the support tube 1 is manufactured from lead-free glass. A sensitive glass membrane 2A is welded to the end face 13a of the tube end 13 of the support tube 1 made of lead-free glass, with a lead glass layer (hereinafter referred to as “binder layer”) 3A between the sensitive glass membrane 2A and the end face 13a of the tube end 13 of the support tube 1. In this embodiment, the junction 2B is also welded to the outer tube 12 of the support tube 1 with a binder layer 3B between the junction 2B and the outer tube 12 of the support tube 1.

Since lead glass and lead-free glass are welded satisfactorily to each other, cracks do not occur in the joint between lead glass and lead-free glass, not only under usual service conditions but also under severe service conditions such as a high temperature and a high alkalinity. As being described later in more detail with reference to the experimental examples, welding of the sensitive glass membrane 2A and the junction 2B to the binder layers 3A and 3B makes it possible to prevent cracks from occurring even under severe service conditions, not depending upon the glass composition of the sensitive glass membrane 2A or the ceramics composition of the junction 2B.

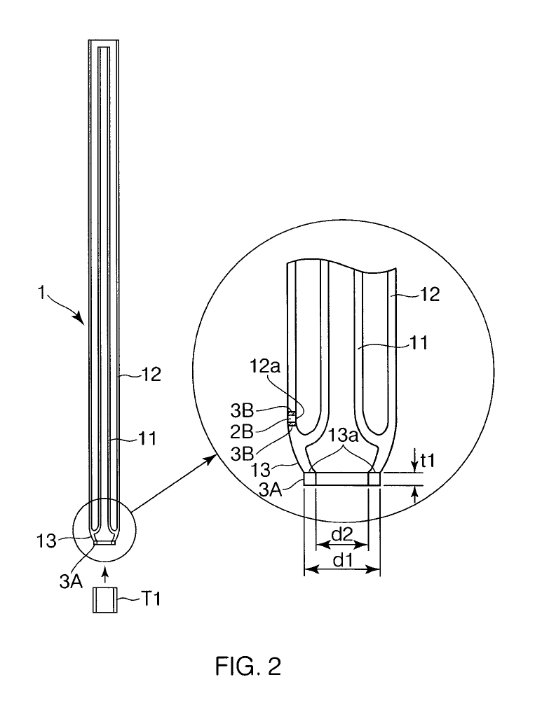

An embodiment of the method for manufacturing the pH electrode 100 will now be described with reference to FIGS. 2 to 4. The method for manufacturing the support tube 1 is not different from the conventional one except that the support tube 1 is manufactured from lead-free glass. In this embodiment, the support tube 1 is a circular tube (circular-section tube). While the support tube 1 is typically a circular tube, the cross-sectional shape of the support tube in the present invention is not limited to this.

First, the method of attaching the sensitive glass membrane 2A to the support tube 1 made of lead-free glass will now be described.

As shown in FIG. 2, when welding the sensitive glass membrane 2A to the support tube 1, the binder layer 3A is formed by welding lead glass in advance to the annular end face 13a of the tube end 13 of the support tube 1, i.e. to the end face 13a to which the sensitive glass membrane 2A is to be welded. Preferably, the binder layer 3A welded to the end face 13a takes substantially the same shape as that of the end face 13a, i.e., an annular shape having substantially the same outside diameter and inside diameter as those of the end face 13a.

A method of welding the binder layer 3A to the end face 13a may be appropriately selected. Typically, the binder layer 3A can be welded to the end face 13a by welding an annular member made of lead glass to the end face 13a, wherein the annular member has substantially the same shape as that of the end face 13a, i.e. substantially the same outside diameter and inside diameter as those of the end face 13a. More specifically, for example, a tubular member (binder tube) T1 having an appropriate length (preferably, about 50 mm), manufactured from lead glass, having substantially the same shape as the end face 13a in cross-section, i.e. substantially the same outside diameter and inside diameter as those of the end face 13a in cross-section, is prepared in advance. The thus prepared binder tube T1 is welded to the end face 13a in a manner of ordinary glasswork using a Bunsen burner. Then, an excessive lead glass portion is cut to adjust the thickness of the binder layer 3A welded to the end face 13a to about 1 mm.

The binder layer 3A should preferably be welded to the end face 13a so that the thickness t1 is equal to or larger than 0.5 mm. When the thickness t1 is smaller than 0.5 mm, uniform formation of the binder layer 3A is difficult, thus reducing the crack-preventing effect at the joint between the sensitive glass membrane 2A and the support tube 1.

On the other hand, the thickness t1 should preferably be equal to or smaller than 5 mm. A thickness t1 larger than this is not desirable because it is difficult to adjust the shape. The thickness t1 should more preferably be up to 2 mm, or further more preferably, up to 1 mm.

In this embodiment, the annular end face 13a of the tube end 13 of the support tube 1 has an outside diameter d1 of 9 mm and an inside diameter d2 of 8 mm. To this annular end face 13a, the binder layer 3A having substantially the same outside diameter and inside diameter as those of the end face 13a is welded so as to give a thickness t1 of 0.5 mm.

After welding the binder layer 3A to the end face 13a of the tube end 13 of the support tube 1 as described above, the sensitive glass membrane 2A is welded via the binder layer 3A to the support tube 1. The method of welding (depositing) the sensitive glass membrane 2A is not different from the conventional one. An outline of a typical such method will be described below.

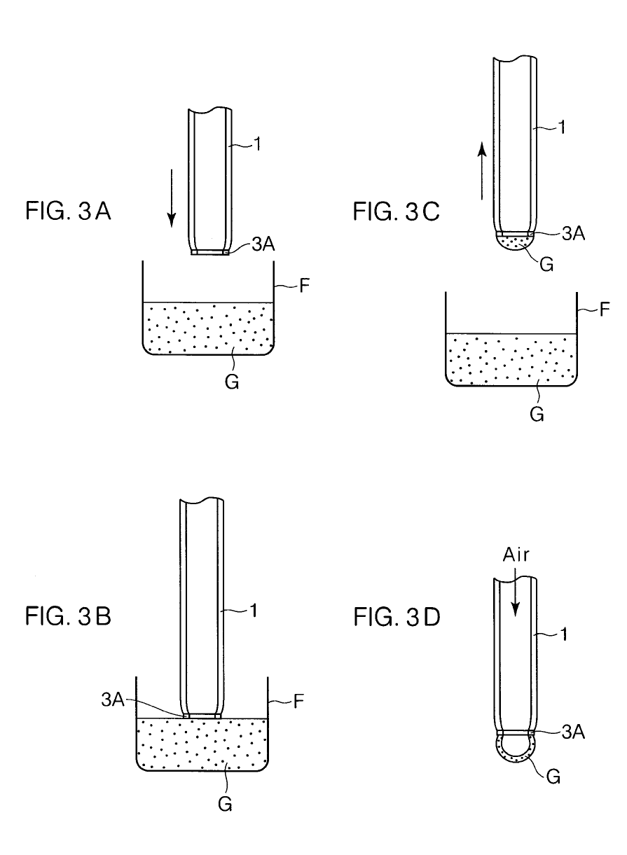

First, as shown in FIG. 3(a), a crucible F containing molten glass (glass membrane seed) G is installed in a furnace (electric furnace), and the support tube 1 is set at a prescribed position above the furnace.

Glass of an appropriate composition may be used for the glass membrane seed G, depending on the use of the pH electrode 100 to be manufactured. Generally, applicable glass compositions include: (a) for standard uses: SiO₂, Li₂O, Cs₂CO₃, BaCO₃, TiO₂, La₂O₃; (b) for alkaline uses: SiO₂, Li₂O, Cs₂CO₃, La₂O₃, Pr₂O₃; (c) for hydrofluoric acid resistant uses: SiO₂, Li₂O, BaCO₃, Ta₂O₅, Cr₂O₃, La₂O₃; and (d) for fermentation uses: SiO₂, Li₂O, BaCO₃, TiO₂, La₂O₃. Values of CTE for the glass membrane seed of these Li-based glass materials are usually within a range from 80 to 120×10⁻⁷/° C.

The temperature of the crucible F inside the furnace is adjusted to an appropriate level (for example, 1,000 to 1,550° C.), and the crucible F is heated for a prescribed period of time. Then, the support tube 1 is lowered at an appropriate speed (for example, 100 to 500 mm/sec) and the tube end of the support tube 1 is immersed in the glass membrane seed G in the crucible F.

As shown in FIG. 3(b), the temperature of the crucible F in which the tube end of the support tube 1 is immersed in the glass membrane seed G is adjusted to an appropriate level (for example, 1,000 to 1,550° C.) by adjusting the temperature inside the furnace, and the glass membrane seed G is caused to adhere to the tube end of the support tube 1 while heating the crucible F for a prescribed period of time.

Then, as shown in FIG. 3(c), the support tube 1 to which the glass membrane seed G adheres is lifted up at an appropriate speed (for example, 500 to 1,500 mm/sec), and then, as shown in FIG. 3(d), air is blown into the support tube 1 to swell the glass membrane seed G adhering to the tube end of the support tube 1 into a desired spherical shape, thereby forming the sensitive glass membrane 2A.

The method of attaching the junction 2B to the support tube 1 will now be described.

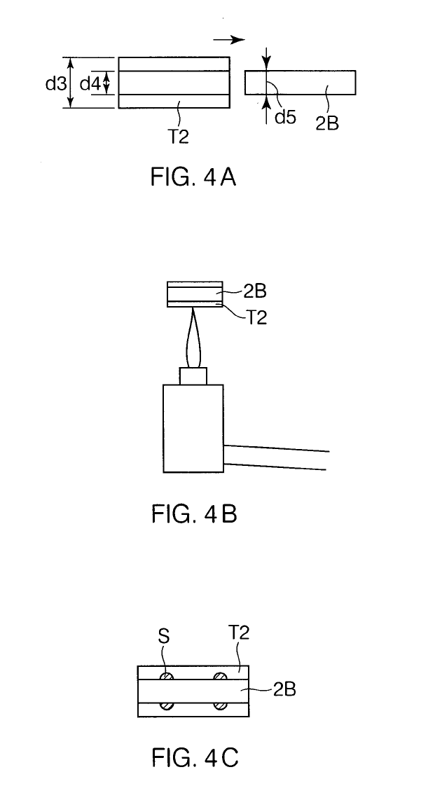

As shown in FIG. 4(a), the junction 2B is put into a tubular member (binder tube) T2 made of lead glass substantially engaging with the junction 2B, in advance. Then, at least a part of the binder tube T2 is preferably caused to melt by roasting by a Bunsen burner as shown in FIG. 4(b), whereby the junction 2B and the binder tube T2 are partially welded to each other at the spot welding portion S (FIG. 4(c)), and the junction 2B and the binder tube T2 are fixed to each other. This prevents the junction 2B from coming off the binder tube T2 during the subsequent operation, thus improving the operability. However, this step of fixing the junction 2B and the binder tube T2 is not always necessary.

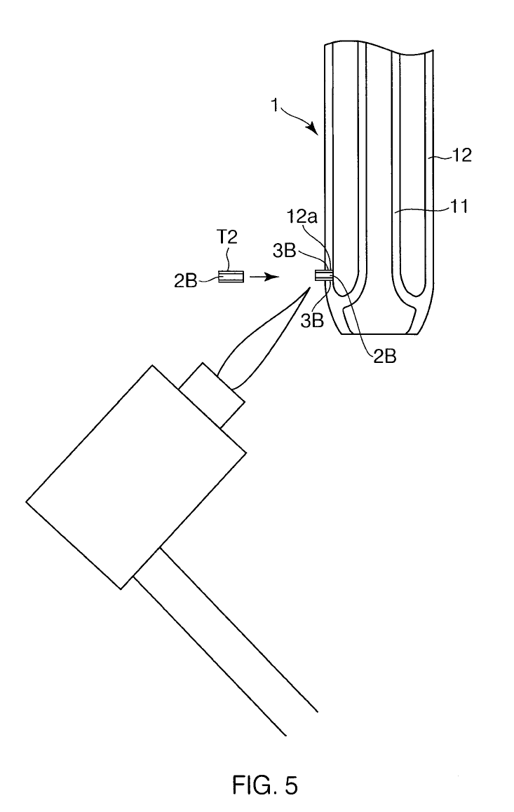

Next, as shown in FIG. 5, a composite member (complex) of the junction 2B and the binder tube T2 is inserted into a hole 12a opened in the outer tube 12 of the support tube 1. The hole 12a is opened in advance by roasting with the Bunsen burner, for example, so as to permit substantial engagement of the composite member of the junction 2B and the binder tube T2 with the hole 12a. Then, the junction 2B is welded to the support tube 1, together with the lead glass of the binder tube T2, by roasting the peripheral edge of this hole 12a and the proximity of the binder tube T2 with the Bunsen burner. This forms the binder layer 3B and seals the junction 2B in the support tube 1.

After sealing, portions of the junction 2B and/or the binder tube T2 projecting outside the outer tube 12 may be removed by filing, for example. Of course, the lengths of the junction 2B and the binder tube T2 may be set to be equal to or shorter than the thickness of the outer tube 12.

For the same reason as that in the case of the binder layer 3A provided at the welding portion of the sensitive glass membrane 2A, a binder layer 3B formed on the junction 2B has a thickness t2, when it is welded to the support tube 1, of 0.5 mm to 5 mm, or more preferably, from 0.5 mm to 2 mm, or further more preferably, from 0.5 mm to 1 mm. The binder tube T2 should preferably have an inside diameter d4 substantially equal to an outside diameter d5 of the junction 2B. An outside diameter d3 of the binder tube T2 is selected so as to obtain a desired thickness t2 of the binder layer 3B after the aforementioned welding. A column-shaped junction 2B having an outside diameter d5 of 1 mm to 1.5 mm is usually used. In this case, usually, a circular tube having an inside diameter d4 substantially equal to the outside diameter d5 of the junction 2B, i.e. of about 1 mm to about 1.5 mm, and an outside diameter d3 of about 1.5 mm to about 2.5 mm, may be suitably used as the binder tube T2.

In this embodiment, as one example, a substantially columnar ceramics having a diameter of about 1 mm cut into length of about 3 mm is employed for the junction 2B. Thus the binder tube T2 used has the outside diameter d3 of 2 mm, and the inside diameter d4 of about 1 mm. This results in the thickness t2 of the binder layer 3B of 0.5 mm.

The shape of the junction 2B is not limited to a columnar shape. Although the binder tube T2 should preferably have a hole having a cross-sectional shape of substantially the same shape as the cross-sectional shape of the junction 2B, it is not limited to this. Any shape of the binder tube T2 is applicable so far as the binder tube T2 is substantially engageable with the junction 2B, and can cover the junction 2B prior to inserting into the hole 12a of the support tube 1.

In the present invention, the method of providing the binder layer 3B is not limited to the above-mentioned method of covering the junction 2B with the binder tube T2 composing the binder layer 3B in advance, inserting the thus covered junction 2B into the hole 12a of the support tube 1, and then, welding the junction 2B, together with the binder tube T2, to the support tube 1. For example, after providing the binder layer 3B on the outer periphery of the junction 2B in the usual method of glasswork with a Bunsen burner employing a glass rod consisting of lead glass as a primary material, the composite member (composite body) of the binder layer 3B and the junction 2B may be inserted into the hole 12a of the support tube 1, and then it may be welded to the support tube 1.

Alternatively, the junction 2B can be attached to the support tube 1 as mentioned below.

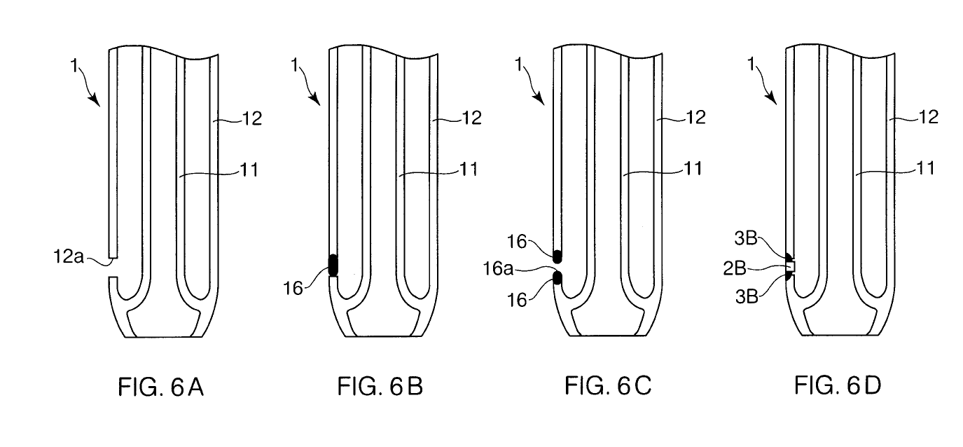

First, as shown in FIG. 6(a), an appropriate hole (first hole) 12a is opened in the outer tube 12 of the support tube 1 made of lead-free glass, at a position where the junction 2B is to be attached. This hole 12a is opened so that the junction 2B and the binder layer 3B fit thereinto. This hole 12a can be opened in the usual method of glasswork using a Bunsen burner. More specifically, the hole can be opened by blowing air, in a state in which glass is softened by roasting it by a Bunsen burner, through a fine tube such as a rubber tube into the softened portion.

Next, as shown in FIG. 6(b), the lead glass 16 is welded in the usual method of glasswork using a Bunsen burner to the hole 12a opened as described above, thus once closing the hole 12a. The lead glass 16 having closed the hole 21a is usually once hardened by cooling.

Subsequently, as shown in FIG. 6(c), another hole (second hole) 16a is opened substantially at the center of the lead glass 16 having closed the hole 12a as described above so as to leave the lead glass 16 therearound. This hole 16a is opened so that the junction 2B adapts thereto. This hole 16a also can be opened in the usual method of glasswork using a Bunsen burner as in the aforementioned case.

Then, as shown in FIG. 6(d), the junction 2B made of ceramics is inserted into the hole 16a opened in the lead glass 16 as described above, and the junction 2B is welded to the hole 16b of the lead glass 16 by roasting the outer peripheries of the junction 2B and the lead glass 16. This permits sealing of the junction 2B, via the binder layer 3B, into the outer tube 12 of the support tube 1.

As in the aforementioned case, the portion of the junction 2B projecting outside the outer tube 12 may be filed off after sealing. Of course, the length of the junction 2B may be set to be equal to or shorter than the thickness of the outer tube.

In the present invention, the composition of lead glass applicable for the binder layer 3 (3A and 3B) is not critical, but any commercially available lead glass can be used without particular limitation so far as it is applicable for an electrochemical sensor. More specifically, lead glass containing PbO of 20 wt. % to 50 wt. % is suitably used. The PbO content smaller or larger than this makes it difficult to obtain functions as the binder layer 3 (3A and 3B). Preferably, lead glass should have a CTE of 94±20×10⁻⁷/° C. on the same level as the CTE of the object to be welded (the sensitive glass membrane 2A and ceramics 2B in this embodiment). So as to be good in workability, lead glass should preferably have a softening point (a temperature at which welding of glass becomes possible in this disclosure) lower than or equal to 900° C.

### EXPERIMENTAL EXAMPLE 1

To confirm advantages of the present invention, the pH electrode having the binder layers 3A and 3B as manufactured by the foregoing manufacturing method (Concrete Example of the Present invention), and the pH electrode having the sensitive glass membrane 2A and the junction 2B welded by the conventional method to the support tube 1 made of lead-free glass without providing the binder layers 3A and 3B (Comparative Example), were compared as to the tendency of crack occurrence relative to the service conditions.

The composition of lead-free glass of the support tube 1 and the composition of the binder layers 3A and 3B are shown in Table 1 below. The glass composition of the support tube 1 was same in all the pH electrodes. The compositions of the binder layers 3A and 3B provided respectively at the welding portions of the sensitive glass membrane 2A and the junction 2B were identical to each other.

TABLE 1

| | | Lead glass | Lead-free glass (1) |
|---|---|---|---|
| | | (Binder) | (Support tube) |
| Glass | SiO₂ | 58.5 | 70 |
| composition | Al₂O₃ | 1 | 2 |
| (wt. %) | B₂O₃ | — | 2 |
| | BaO + PbO | 28 | — |
| | Na₂O + K₂O | 12.5 | — |
| | RO | — | 11 |
| | (R: bivalent | | |
| | metal element) | | |
| | R₂O | — | 15 |
| | (R: monovalent | | |
| | metal element) | | |

| | | |
|---|---|---|
| Coefficient of linear | 94 | 94.5 |
| thermal expansion | | |
| (×10⁻⁷/° C.) | | |

For the purpose of comparing tendencies of crack occurrence depending on the difference in the glass composition of the sensitive glass membrane 2A, pH electrodes were prepared respectively using a standard membrane (having the binder layer 3A: Concrete Example 1; not having the binder layer 3A: Comparative Example 1), and a membrane for high alkalinity (having the binder layer 3A: Concrete Example 2; not having the binder layer 3A: Comparative Example 2) with the glass compositions shown in Table 2 below.

TABLE 2

| | | Standard | Membrane |
|---|---|---|---|
| | | membrane | for higt alkalinity |
| Glass | SiO₂ | 50~55 | 55~60 |
| composition | Li₂O | 28~30 | 28~30 |
| (wt. %) | BaO | 2~5 | 2~5 |
| | La₂O₃ | 3~6 | 3~6 |
| | Cs₂O | 0~1 | 2~3 |
| | TiO₂ | 3~8 | 3~8 |

| | | |
|---|---|---|
| Coefficient of linear | 100~110 | 115~120 |
| thermal expansion | | |
| (×10⁻⁷/° C.) | | |

For the purpose of comparing tendencies of crack occurrence depending on the difference in the ceramics composition of the junction 2B, pH electrodes were prepared respectively using alumina-based ceramics (having the binder layer 3B: Concrete Example 3; not having the binder layer 3B: Comparative Example 3), cerium-based ceramics (having the binder layer 3B: Concrete Example 4; not having the binder layer 3B: Comparative Example 4), magnesia-based ceramics (having the binder layer 3B: Concrete Example 5; not having the binder layer 3B: Comparative example 5), and zirconia-based ceramics (having the binder layer 3B: Concrete Example 6; not having the binder layer 3B: Comparative Example 6) with the chemical compositions shown in Table 3 below.

TABLE 3

| | | Almina- | Cerium- | Magnesia- | Zirconia- |
|---|---|---|---|---|---|
| | | based | based | based | based |
| Glass | Al₂O₃ | 90~98 | 15~20 | — | 0~3 |
| composition | CaO | 0~2 | — | 0~5 | 3~10 |
| (wt. %) | MgO | 1~5 | 5~10 | 60~80 | 0~3 |
| | CeO₂ | — | 70~80 | — | — |
| | SiO₂ | — | — | 20~40 | 0~4 |
| | ZrO₂ | — | — | — | 80~95 |
| | HfO₂ | — | — | — | 0~3 |

| | | | | |
|---|---|---|---|---|
| Weldeng property | X | ◯ | ◯ | ◯ |
| to lead-free glass | | | | |

### RESULT

### 1) Processability and Workability:

The lead-free glass used had a softening point lower than 900° C., and processability and workability themselves were good as the conventional lead glass.

The cases where the binder layer 3A or 3B was provided (Concrete Examples 1 to 6) showed good welding property between lead glass and lead-free glass. Welding property between lead glass and the sensitive glass membrane 2A or the junction 2B was also good.

### 2) Sensitive Glass Membrane:

When the standard membrane was used as the sensitive glass membrane 2A, crack occurrence was not observed at the joint between the support tube 1 and the sensitive glass membrane 2A, even after a measurement for a long period of time (for longer than 5 hours; same applies to others hereafter) with any of room-temperature (25° C.; same applies to others hereafter) water, high-temperature (100° C.; same applies to others hereafter) water, and high-temperature and high-alkalinity solution (aqueous solution of sodium hydroxide with a pH of 13; same applies to others hereafter), in both cases where the binder layer 3A was provided (Concrete Example 1) and where the binder layer 3A was not provided (Comparative Example 1).

When the membrane for high alkalinity was used as the sensitive glass membrane 2A, in the case where the binder layer 3A was not provided (Comparative Example 2), cracks occurred at the joint between the support tube 1 and the sensitive glass membrane 2A after a measurement for a long period of time with high-temperature water, or high-temperature and high-alkalinity aqueous solution, while no problem was encountered with room-temperature water. In the case where the binder layer 3A was provided (Concrete Example 2), in contrast, crack occurrence was not observed at the joint between the support tube 1 and the sensitive glass membrane 2A, even after a measurement for a long period of time with any of room-temperature water, high-temperature water, and high-temperature and high-alkalinity aqueous solution.

As described above, it is found that, when the binder layer 3A is not provided, cracks occur more easily in the case where the membrane for high alkalinity is used as the sensitive glass membrane 2A than in the case where the standard membrane is used. When using the standard membrane, it seems that it is difficult for cracks to occur because the CTE of the standard membrane is close to that of the lead-free glass. On the other hand, the membrane for high alkalinity has a larger CTE, and thus the lead-free glass cannot absorb the difference in the CTE, and this is considered to leads to easier occurrence of cracks under high-temperature condition. High-alkalinity condition seems to foment this easier occurrence of cracks.

Among the compositions of the sensitive glass membrane shown in Table 2, components contributing to the CTE are SiO₂, Li₂O, and Cs₂O. There is almost no difference in the SiO₂ and Li₂O compositions between the standard membrane and the membrane for high alkalinity, whereas there is a large difference in Cs₂O. This difference largely contributes to the value of CTE, and is considered to be related with the tendency of crack occurrence. However, since a less Cs₂O content leads to increase of alkaline error at a high alkalinity, the quantity of Cs₂O cannot be reduced in the membrane for high alkalinity.

When welding the sensitive glass membrane 2A to the support tube 1 via the binder layer 3A in accordance with this embodiment, it is possible to prevent occurrence of cracks, irrespective of the service conditions both for the standard membrane and the membrane for high alkalinity. Although the present invention is not bound by a theory, the reason is considered as follows. By providing the binder layer 3A which can be welded satisfactorily both to the support tube 1 and to the sensitive glass membrane 2A, between the support tube 1 and the sensitive glass membrane 2A which is the object to be welded, the support tube 1 and the sensitive glass membrane 2A do not come into direct contact with each other. As a result, a sufficient processing accuracy is available from flexibility of lead glass in its molten state as described above, and flexibility of lead glass is considered to enable the binder layer 3A to absorb the difference in CTE between the lead-free glass and the sensitive glass membrane 2A.

As is understood from the above, when the membrane for high alkalinity is used as the sensitive glass membrane 2A, or more specifically, when the glass composition of the sensitive glass membrane 2A contains Cs₂O of at least 2 wt. %, cracks tend to occur more easily. The advantages of the present invention therefore become very remarkable especially when using such a membrane for high alkalinity as the sensitive glass membrane 2A. However, as is clear from the aforementioned result of experiment, durability under severe service conditions can be improved by providing the binder layer 3A. Therefore, even when using the standard membrane which makes it relatively difficult to generate cracks as the sensitive glass membrane 2A, it is very favorable to provide the binder layer 3A in accordance with this embodiment, considering, for example, the case where a measurement is performed for a long period of time under a condition of higher temperature, and this permits improvement of reliability of the electrode.

### 3) Junction:

When ceramics other than alumina-based ceramics, i.e. cerium-based ceramics, magnesia-based ceramics or zirconia-based ceramics was used as the junction 2A, crack occurrence was not observed at the joint between the support tube 1 and the junction 2B, even after a measurement for a long period of time with any of room-temperature water, high-temperature water, and high-temperature and high-alkalinity solution, in both cases where the binder layer 3B was provided (Concrete Examples 4 to 6) and where the binder layer 3B was not provided (Comparative Examples 4 to 6).

When alumina-based ceramics was used as the junction 2B, cracks occurred at the joint between the support tube 1 and the junction 2B after a measurement for more than 24 hours even with room-temperature water in the case where the binder layer 3A was not provided (Comparative Example 3). Cracks tended to occur more easily with high-temperature water, and high-temperature and high-alkalinity aqueous solution. In these cases, crack occurrence was observed in a measurement for more than an hour. In the case where the binder layer 3B was provided (Concrete Example 3), in contrast, crack occurrence was not observed at the joint between the support tube 1 and the sensitive glass membrane 2A, even after a measurement for a long period of time with any of room-temperature water, high-temperature water, and high-temperature and high-alkalinity aqueous solution.

As described above, it is found that, when the binder layer 3B is not provided, cracks occur more easily in the case where alumina-based ceramics is used than in the case where the other kind of ceramics is used. High-alkalinity condition seems to accelerate this easier occurrence of cracks.

As shown in Table 3, applicable ceramics as the junction include alumina-based ceramics, cerium-based ceramics, magnesia-based ceramics and zirconia-based ceramics, in terms of the main component, i.e. in terms of the component contained in the largest amount. Alumina-based ceramics is experimentally-found to provide the best performance as the junction. However, cracks most easily occur when using this alumina-based ceramics, in the case where the binder layer 3B is not used. Occurrence of cracks is more difficult when using ceramics other than alumina-based ceramics, i.e. cerium-based ceramics, magnesia-based ceramics and zirconia-based ceramics. However, these ceramics other than alumina-based ceramics are experimentally-found to be inferior to alumina-based ceramics in terms of the performance as the junction 2B.

When the junction 2B is sealed in the support tube 1 via the binder layer 3B in accordance with this embodiment, it is possible to prevent occurrence of cracks irrespective of the service conditions, not depending upon which kind of ceramics is used as the junction 2B. Although the present invention is not bound by a theory, the reason is considered as follows. As in the above-mentioned case of the welding portion of the sensitive glass membrane 2A, by providing the binder layer 3B which can be satisfactorily welded to any of the support tube 1 and the junction 2B between the support tube 1 and the junction 2B which is the object to be welded, the support tube 1 and the junction 2B do not come into direct contact with each other. As a result, a sufficient processing accuracy is available from flexibility of lead glass in its molten state as described above, and flexibility of lead glass is considered to enable the binder layer 3B to absorb the difference in CTE between the lead-free glass and the junction 2B.

According to this embodiment, as is understood from the above, the crack-preventing effect becomes very remarkable particularly when using alumina-based ceramics as the junction 2B. However, as is clear from the aforementioned result of experiment, durability under severe service conditions can be improved by providing the binder layer 3B. Therefore, even when using ceramics other than alumina-based ceramics, i.e. cerium-based ceramics, magnesia-based ceramics or zirconia-based ceramics which makes it relatively difficult to generate cracks, it is very favorable to provide the binder layer 3B in accordance with this embodiment, considering, for example, the case where a measurement is performed for a long period of time under a condition of higher temperature, and this permits improvement of reliability of the electrode.

### EXPERIMENTAL EXAMPLE 2

Experiments similar to those of the aforementioned Experimental Example 1 were carried out by using each lead-free glass shown in the following Table 4 in place of the lead-free glass shown in Table 1 as the lead-free glass for the support tube 1.

As the lead-free glass shown in Table 1, each lead-free glass shown in Table 4 had a softening point lower than 900° C., and processability and workability themselves were good as the conventional lead glass. As the lead-free glass shown in Table 1, welding property between lead glass and lead-free glass was good when providing the binder layer 3A or 3B. Welding property between lead glass and the sensitive glass membrane 2A or the junction 2B was also good.

The tendency of crack occurrence in the case where the binder layer 3A or 3B was not used, and the crack-preventing performance in the case where the binder layer 3A or 3B was provided were substantially the same as the results of the above-mentioned Experimental Example 1.

TABLE 4

| | | Lead-free glass (2) | Lead-free glass (3) |
|---|---|---|---|
| | | (Support tube) | (Support tube) |
| Glass | SiO₂ | 66 | 63 |
| composition | Na₂O | 8 | 11 |
| (wt. %) | Li₂O | 4.9 | 4.9 |
| | K₂O | 4.8 | 4.8 |
| | SrO | 5.5 | 5.5 |
| | CaO | 3.8 | 3.8 |
| | BaO | 3 | 3 |
| | MgO | 2 | 2 |
| | ZnO | 0 | 0 |
| | Al₂O₃ | 2 | 2 |

| | | |
|---|---|---|
| Coefficient of linear | 94 | 105 |
| thermal expansion | | |
| (×10⁻⁷/° C.) | | |

In the present invention, the composition of lead-free glass applicable as the material for the support tube 1 is not critical, but any commercially available lead-free glass can be used without particular limitation so far as it is glass not containing lead, and is suitable for forming the support tube 1 of the electrochemical sensor. Preferably, lead-free glass should have a CTE of 94±20×10⁻⁷/° C. on the same level as the CTE of the object to be welded (the sensitive glass membrane 2A and ceramics 2B in this embodiment), and a glass composition not containing lead. Apart from the above, it is important that the material for the support tube 1 for the electrochemical sensor is good in easiness of manufacture (processability and workability), water resistance, weather resistance, and transparency. So as to be good in workability, lead-free glass should preferably have a softening point lower than or equal to 900° C.

The present applicant proposed the lead-free glass composition suitably applicable for the electrochemical sensor, which is relatively low-temperature softening, good in processability, workability, water resistance, weather resistance and transparency, as is disclosed in Japanese Patent Application Publication No. 2005-207887. In the present invention, the lead-free glass disclosed in the foregoing prior art document is suitably employed. Each lead-free glass shown in Table 4 is the one which is prepared in accordance with the invention disclosed in the aforementioned prior art document.

More specifically, as lead-free glass composing the support tube 1, the glass composition containing, in weight percentage, 60 to 75% SiO₂, 2 to 14% Na₂O, 0 to 9% Li₂O, 1 to 9% K₂O (where, 10 to 25% Na₂O+Li₂O+K₂O), 0 to 9% SrO, 1 to 9% CaO, 1 to 6% BaO, 0 to 6% MgO, 0 to 6% ZnO (where, 10 to 25% SrO+CaO+BaO+MgO+ZnO), and 0 to 6% Al₂O₃ is suitably applicable.

As is disclosed in the above-mentioned prior art document, the lead-free glass should preferably have the aforementioned composition for the following reasons.

SiO₂ is a skeleton component composing a glass network, and the SiO₂ content smaller than 60 wt. % makes it difficult to achieve vitrification. On the other hand, if the SiO₂ content is larger than 75 wt. %, the glass softening temperature becomes too high, leading to lower processability and workability.

Both Na₂O and K₂O have a function of increasing the low-temperature softening property. Further, these components increase CTE. When taking into account processability and workability of the electrode supporting member, glass should preferably have a softening point equal to or lower than 900° C. Therefore, at least 2 wt. % of Na₂O and at least 1 wt. % of K₂O should be contained. On the other hand, excessively high contents of these components lead to degradation of water resistance and weather resistance, and to an excessively high CTE. Therefore, the Na₂O content should be up to 14 wt. %, and the K₂O content should be up to 9 wt. %.

As in the case of Na₂O and K₂O, Li₂O has a function of increasing the low-temperature softening property. If Na₂O and K₂O are contained within the aforementioned ranges, the Li₂O content should be up to 9 wt. %. If this range is exceeded, water resistance and weather resistance are degraded, and CTE becomes too high.

In order to achieve the low-temperature softening property, avoid degradation of water resistance and weather resistance, and prevent CTE from becoming too high, the aforementioned Na₂O, K₂O and Li₂O should be contained within a range from 10 to 25 wt. % in total.

SrO is a glass network modifying oxide and effective for improving water resistance and weather resistance. It is useful, when used in an appropriate amount, for preventing devitrification and improving processability. SrO furthermore increases CTE. When CaO and BaO are contained within the following range, the SrO content should be up to 9 wt. %. If this range is exceeded, devitrification may be caused, bubble removal may be degraded, and CTE becomes too high.

As SrO mentioned above, each of CaO and BaO is a glass network modifying oxide, and effective for improving water resistance and weather resistance. These are useful, if used in an appropriate amount, for preventing devitrification and improving processabiltiy. Further, these components raise CTE. In order to obtain a desired effect, the CaO content should be up to 1 wt. %, and the BaO content should be at least 1 wt. %. On the other hand, these components, if contained too much, may cause devitrification, lead to degradation of bubble removal, and excessively raise CTE. The CaO content should therefore be up to 9 wt. %, and the BaO content, up to 6 wt. %.

MgO is useful for improving processability, but, if contained too much, it may causes degradation of weather resistance and water resistance. Therefore, the MgO content should be up to 6 wt. %. MgO has no marked effect on CTE.

ZnO is effective for decreasing the softening point. Further, ZnO lowers CTE. An excessively high ZnO content reduces water resistance. Therefore, the ZnO content should be up to 6 wt. %.

However, in order to improve water resistance and weather resistance, prevent devitrification, improve processability, as well as to limit CTE within a desired range, it is preferable to limit the total content of SrO, CaO, BaO, MgO and ZnO within a range from 10 to 25 wt. %. If this content exceeds 25 wt. %, weather resistance and water resistance are reduced. Also, if this content is smaller than 1 wt. %, there cannot be attained a sufficient effect.

Al₂O₃, if contained in a small amount, is effective for inhibiting devitraification and improving water resistance and weather resistance, but a high content impairs the low-temperature softening property. The Al₂O₃ content should therefore be up to 6 wt. %. Al₂O₃ has no marked effect on CTE.

In this embodiment, the description has been made based particularly on the case where the glass electrode serving as the electrochemical sensor is the pH electrode having the pH glass electrode sensing pH as the sensitive glass membrane. However, the present invention is equally applicable to the case where the glass electrode is the ion electrode other than the pH electrode. In this case, the sensitive glass membrane may have a known glass composition sensitive to ion to be measured.

Manufacturing the support tube serving as the electrode supporting member from glass is very favorable because of many advantages including the good workability, and the possibility to select the material having a CTE close to that of the object to be welded. However, as is understood from the above, provision of the binder layer displays the function of absorbing the difference in CTE between the support tube and the object to be welded. Therefore, the support tube can be manufactured from an arbitrary material not containing lead, including the lead-free glass in this embodiment, so far as the material has a CTE close to that of the lead glass of the binder layer, or more specifically, a CTE of 94±20×10⁻⁷/° C.

According to the present embodiment, as described above, it is possible to prevent occurrence of cracks at the welding portion between the support tube 1 made of lead-free glass and the sensitive glass membrane 2A or the junction 2B made of ceramics.

### INDUSTRIAL APPLICABILITY

According to the present invention, as described above, the electrochemical sensor has the configuration in which the sensitive glass membrane is welded to the support tube made of lead-free glass with the lead glass layer between the sensitive glass membrane and the support tube, or the configuration in which ceramics for the junction is welded to the support tube made of lead-free glass with the lead glass layer between the ceramics and the support tube. It is therefore possible to prevent occurrence of cracks at the welding portion between the support tube and the sensitive glass membrane or ceramics.

1. An electrochemical sensor wherein a sensitive glass membrane is welded to a support tube made of lead-free glass with a lead glass layer between the sensitive glass membrane and the support tube.

2. The electrochemical sensor according to claim 1, wherein an annular lead glass layer is welded to an annular end face of the support tub e, and the sensitive glass membrane is welded to an end face of the annular lead glass layer.

3. The electrochemical sensor according to claim 2, wherein the support tube has a double tube structure having an inner tube and an outer tube; a tube end of the outer tube is welded to a tube end of the inner tube and sealed thereto; and the annular end face is formed on the tube end of the support tube.

4. The electrochemical sensor according to claim 1, wherein ceramics for a junction is welded to the support tube with a lead glass layer between the ceramics and the support tube.

5. The electrochemical sensor according to claim 3, wherein ceramics for a junction is welded to the outer tube of the support tube with a lead glass layer between the ceramics an the outer tube of the support tube.

6. The electrochemical sensor according to claim 1, which is a pH electrode.

7. The electrochemical sensor according to claim 1, wherein the sensitive glass membrane is a membrane for high alkalinity.

8. An electrochemical sensor wherein ceramics for a junction is welded to a support tube made of lead-free glass with a lead glass layer between the ceramics and the support tube.

9. The electrochemical sensor according to claim 8 which is a reference electrode.

10. The electrochemical sensor according to claim 4, wherein the ceramics for the junction is alumina-based ceramics.

11. The electrochemical sensor according to claim 1, wherein the lead-free glass has a coefficient of thermal expansion (coefficient of linear thermal expansion) of 94±20×10⁻⁷/° C.

12. An electrochemical sensor wherein a sensitive glass membrane or ceramics for a junction is welded to a support tube made of a material having a coefficient of thermal expansion (coefficient of linear thermal expansion) of 94±20×10⁻⁷/° C. with a lead glass layer between the sensitive glass membrane of the ceramics and the support tube.

13. The electrochemical sensor according to claim 1, wherein the lead glass layer has a thickness of 0.5 mm to 5 mm.

14. A method for manufacturing an electrochemical sensor comprising welding a sensitive glass membrane to a support tube made of lead-free glass with a lead glass layer between the sensitive glass membrane and the support tube.

15. The method according to claim 14 comprising the steps of:
(a) welding an annular lead glass layer to an annular end face of the support tube made of lead-free glass; and
(b) welding the sensitive glass membrane to an end face of the annular lead glass layer.

16. The method according to claim 15, wherein step (a) comprises a step of welding an annular member made of lead glass having substantially the same shape as the of the annular end face of the support tube to the annular end face of the support tube.

17. The method according to claim 15, wherein step (b) comprises a step of welding a molten membrane seed of the sensitive glass membrane to the end face of the lead glass layer, and then swelling the membrane seed into a desired spherical shape by blowing air into the support tube.

18. A method for manufacturing an electrochemical sensor comprising welding ceramics for a junction to a support tube made of lead-free glass with a lead glass layer between the ceramics and the support tube.

19. The method according to claim 18 comprising the steps of:
(i) putting the ceramics for the junction into a tubular member made of lead glass substantially engaging with the ceramics for the junction;
(ii) inserting a composite member, formed in step (i), of the ceramics for the junction and the tubular member made of lead glass into a hole opened in the support tube made of lead-free glass; and
(iii) welding the ceramics for the junction, together with the tubular member made of lead glass, to the support tube.

20. The method according to claim 19, further comprising a step of partially welding the tubular member made of lead glass and the ceramics for the junction between step (i) and step (ii).

21. The method according to claim 18 comprising the steps of:
(I) opening a first hole in the support tube made of lead-free glass;
(II) closing the first hole by welding lead glass to the first hole opened in step (I);
(III) opening a second hole substantially at the center of the lead glass having closed the first hole in step (II) so as to leave the lead glass around the second hole; and
(IV) inserting the ceramics for the junction into the second hole opened in step (III), and then welding the ceramics to the second hole.

22. A method for manufacturing an electrochemical sensor comprising welding a sensitive glass membrane or ceramics for a junction to a support tube made of a material having a coefficient of thermal expansion (coefficient of linear thermal expansion) of 94±20×10⁻⁷/° C. with a lead glass layer between the sensitive glass membrane or the ceramics and the support tube.

23. The method according to claim 14, wherein the lead glass layer has a thickness of 0.5 mm to 5 mm.
